(19) United States
(12) Patent Application Publication
(10) Pub. No.: US 2026/0122518 A1
(43) Pub. Date: Apr. 30, 2026

(54) COMPUTER-READABLE RECORDING MEDIUM STORING ESTIMATION PROGRAM, ESTIMATION METHOD, AND INFORMATION PROCESSING APPARATUS

(71) Applicant: Fujitsu Limited, Kawasaki-shi (JP)

(72) Inventors: Natsuki ISHIKAWA, Yamato (JP); Yoshihiro OKAWA, Yokohama (JP); Masatoshi OGAWA, Zama (JP)

(73) Assignee: Fujitsu Limited, Kawasaki-shi (JP)

(21) Appl. No.: 19/009,015

(22) Filed: Jan. 3, 2025

(30) Foreign Application Priority Data
Feb. 8, 2024 (JP) 2024-018150

(51) Int. Cl. H04W 24/08; H04W 24/02; H04W 28/02

(52) U.S. Cl. CPC H04W 24/08; H04W 24/02; H04W 28/0226

(57) ABSTRACT

A non-transitory computer-readable recording medium stores a program for causing a computer to execute an estimation process including: setting a plurality of predetermined positions, a position of a base station, and communication volume of the base station for each predetermined time in a target area; and estimating the communication volume of each of the predetermined positions based on at least one of a first correlation of the communication volume based on the predetermined positions and another predetermined position or a second correlation based on a time of the communication volume of the predetermined positions at a time of estimating the communication volume of each of the predetermined positions in the predetermined time on an assumption of a terminal that communicates with the base station for each of the predetermined positions based on the setting.

### CROSS-REFERENCE TO RELATED APPLICATION

This application is based upon and claims the benefit of priority of the prior Japanese Patent Application No. 2024-18150, filed on Feb. 8, 2024, the entire contents of which are incorporated herein by reference.

### FIELD

The embodiment discussed herein is related to an estimation program, an estimation method, and an information processing apparatus.

### BACKGROUND

In design of a radio access network (RAN), positions of a base station (BS) and terminal (user equipment (UE)) and a traffic demand of each UE are commonly input to simulate connection between each UE and the BS using a simulator, thereby calculating indices such as communication quality, power consumption, and the like. This simulation needs spatial traffic distribution in a target area.

International Publication Pamphlet No. WO 2010/110187, Japanese National Publication of International Patent Application No. 2022-502902, U.S. Patent Application Publication No. 2018/0254979, U.S. Patent Application Publication No. 2002/0013152, and G. Barlacchi, M. D. Nadai, R. Larcher, A. Casella, C. Chitic, G. Torrisi, F. Antonelli, A. Vespignani, A. Pentland, and B. Lepri, “A multi-source dataset of urban life in the city of Milan and the province of Trentino”, Scientific Data, vol. 2, 150055, October 2015 are disclosed as related art.

### SUMMARY

According to an aspect of the embodiments, a non-transitory computer-readable recording medium stores a program for causing a computer to execute an estimation process including: setting a plurality of predetermined positions, a position of a base station, and communication volume of the base station for each predetermined time in a target area; and estimating the communication volume of each of the predetermined positions based on at least one of a first correlation of the communication volume based on the predetermined positions and another predetermined position or a second correlation based on a time of the communication volume of the predetermined positions at a time of estimating the communication volume of each of the predetermined positions in the predetermined time on an assumption of a terminal that communicates with the base station for each of the predetermined positions based on the setting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining an assumption of a UE at each grid point;

FIG. 2 is an explanatory diagram for explaining an outline of traffic of a BS;

FIG. 3 is an explanatory diagram for explaining a relationship between elements;

FIG. 4 is an explanatory diagram for explaining the outline of the traffic of the BS in consideration of the relationship between the elements;

FIG. 5 is a block diagram illustrating an exemplary functional configuration of an information processing apparatus according to an embodiment;

FIG. 6 is a flowchart illustrating exemplary operation of the information processing apparatus according to the embodiment;

FIG. 7 is a flowchart illustrating an example of a traffic distribution generation process;

FIG. 8 is an explanatory diagram for explaining exemplary calculation;

FIG. 9 is an explanatory diagram for explaining exemplary calculation;

FIG. 10 is an explanatory diagram for explaining an outline of traffic of a BS according to a variation;

FIG. 11 is a flowchart illustrating exemplary operation of an information processing apparatus according to the variation;

FIG. 12 is a flowchart illustrating an example of the traffic distribution generation process; and

FIG. 13 is an explanatory diagram for explaining an exemplary computer configuration.

### DESCRIPTION OF EMBODIMENTS

With regard to this spatial traffic distribution, there is an existing technique in which a lattice-shaped grid is set and traffic of each grid is determined according to overlap between a coverage area of the BS and the grid based on performance management data (PM data) obtained at the time of operating the BS.

However, since the existing technique described above assumes that, for example, the traffic is evenly generated in the coverage area of one BS, there is a problem that the reproduction accuracy of the traffic distribution is low.

In one aspect, an object is to provide an estimation program, an estimation method, and an information processing apparatus capable of accurately estimating traffic distribution.

Hereinafter, an estimation program, an estimation method, and an information processing apparatus according to an embodiment will be described with reference to the drawings. Components having the same functions in the embodiment are denoted by the same reference signs, and redundant description will be omitted. Note that the estimation program, the estimation method, and the information processing apparatus to be described in the following embodiment are merely examples, and do not limit the embodiment. Furthermore, each embodiment below may be appropriately combined unless otherwise contradicted.

First, an outline of the information processing apparatus according to the embodiment will be described. The information processing apparatus according to the embodiment is a device that estimates traffic distribution in a target area based on PM data and a position of each BS, and for example, a personal computer (PC) or the like may be adopted. Here, the target area is preset as a range for obtaining traffic distribution, and for example, a range of several square kilometers is set.

The information processing apparatus according to the embodiment sets, for example, a grid for the target area, and assumes that a terminal (UE) that communicates with the BS exists at each of a plurality of grid points of the grid. Hereinafter, the plurality of grid points in the target area will be referred to as UEgrid. Note that the grid point is an example of a predetermined position.

Note that the UEgrid may be optionally set in the target area. For example, the density of the grid points may be increased in a densely populated area, and the density of the grid points may be decreased in a sparsely populated area.

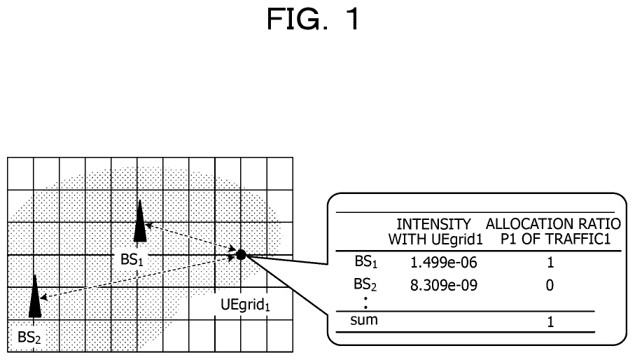

FIG. 1 is an explanatory diagram for explaining an assumption of a UE at each grid point. As illustrated in FIG. 1, the information processing apparatus according to the embodiment assumes that a UE exists at each grid point, and obtains traffic between each UEgrid and the BS. As a result, spatial traffic distribution is obtained.

Here, the following is assumed as a relationship between the UEgrid and the PM data of the BS. First, it is assumed that the traffic of each UEgrid is distributed to each BS according to the intensity between the UEgrid and each BS. In addition, it is assumed that the communication volume indicated by the PM data of a certain BS is the sum of the traffic allocated from all UEgrids.

For example, traffic₁ of a UEgrid₁ is allocated according the intensity between the UEgrid₁ and a BS₁, BS₂, and so on. An allocation ratio P₁ of the UEgrid₁ is 1 for the BS₁ with the highest intensity and 0 for other BSs. Accordingly, the traffic₁ of the UEgrid₁ is entirely allocated to the BS₁. Furthermore, the communication volume indicated by the PM data of the BS₁ is the sum of the traffic of the UEgrid₁, UEgrid₂, and so on allocated to the BS₁.

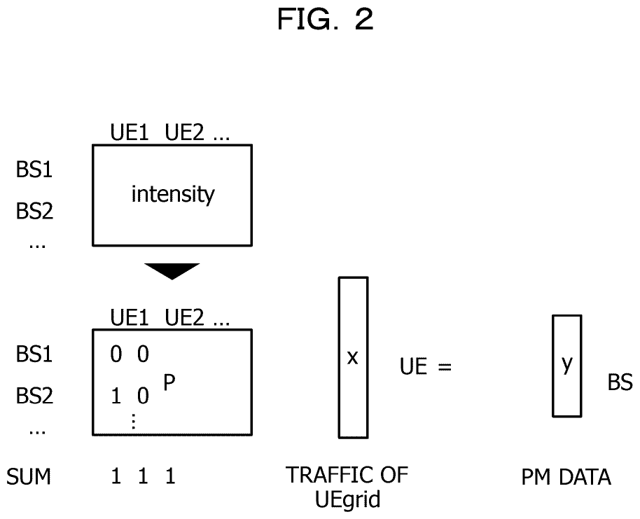

FIG. 2 is an explanatory diagram for explaining an outline of traffic of a BS. As illustrated in FIG. 2, the information processing apparatus according to the embodiment calculates intensity by combinations of all UEgrids and BSs.

For example, the information processing apparatus according to the embodiment calculates intensity (S_{i,k}) between the UEgrid (k) and the BS (i) as expressed in the following formula (1).

$$\begin{matrix}[ Math . 1 ] & \\ {s}_{i , k} = {p}_{i} - {l}_{i , k} & ( 1 )\end{matrix}$$

Here, pᵢ represents transmission power of the BS (i). A path loss between the UEgrid (k) and the BS (i) is represented by l_{i,k}, which is calculated based on the information defined in the 3rd Generation Partnership Project (3GPP) (registered trademark) based on the position, frequency, height, and the like of the UEgrid (k) and BS (i).

The information processing apparatus according to the embodiment calculates the allocation ratio with respect to each BS for each UEgrid based on the intensity of each of the combinations of all UEgrids and BSs, and sets a matrix P as expressed in the following formula (2).

$$\begin{matrix}[ Math . 2 ] & \\ P = [ \begin{matrix}{r}_{1 , 1} & … & {r}_{1 , m} \\ ⋮ & ⋱ & ⋮ \\ {r}_{n , 1} & … & {r}_{n , m}\end{matrix} ] & ( 2 )\end{matrix}$$

Here, r_{i,k} represents the allocation ratio of the traffic of the UEgrid (k) to the BS (i). This r_{i,k} is calculated as in the following formula (3), for example.

$$\begin{matrix}[ Math . 3 ] & \\ {r}_{i , k} = \{ \begin{matrix}1 if i = {arg max}_{i} {s}_{i , k} \\ 0 otherwise\end{matrix} & ( 3 )\end{matrix}$$

In this formula (3), the rule is that the UE is coupled to the BS having the maximum intensity, and for each UE, the BS having the maximum intensity is set to 1, and other BSs are set to 0.

Note that the calculation of the allocation ratio is not limited to the formula (3), and may be appropriately determined based on a connection rule at the time of network operation. For example, the rule may be that the UE is coupled to a plurality of BSs in descending order of intensity. Furthermore, an index for calculating the intensity may also be changed as appropriate.

Here, the traffic of the UEgrid is assumed to be x and [x₁ . . . xₘ]^{T}. In addition, the PM data (traffic for each BS) is assumed to be y and [y₁ . . . yₙ]^{T}. Px=y holds for a relationship between the UEgrid and the PM data of the BS.

The information processing apparatus according to the embodiment solves an optimization problem of the following formula (4) based on the PM data (traffic for each BS), thereby obtaining the traffic of each UEgrid, for example, the traffic distribution.

$$\begin{matrix}[ Math . 4 ] & \\ {arg min}_{x} {‖ Px - y ‖}^{2} where x \geq 0 & ( 4 )\end{matrix}$$

Here, the size of the matrix P is the number of BSs x the number of UEgrids. Thus, when the number of UEgrids to be obtained is larger than the number of BSs or when the rank of the matrix P is lowered, the number of unknowns is larger than the number of equations, and the solution is not fixed to one.

In view of the above, the information processing apparatus according to the embodiment adds a correlation between elements of x to the relational expression (Px=y) between the UEgrid and the PM data of the BS, and solves an optimization problem including the added correlation, thereby estimating the traffic of each UEgrid.

Here, the correlation between the elements of x includes a correlation (first correlation) of the communication volume based on the positions of the grid point and another grid point and a correlation (second correlation) based on the time of the communication volume of the grid point. First, the embodiment in which the first correlation is added to the relational expression (Px=y) between the UEgrid and the PM data of the BS will be described, and the case of adding the second correlation will be described later as a variation.

The correlation (first correlation) of the communication volume based on the positions of the grid point and another grid point reproduces a correlative relationship that the traffic of UEgrids close to each other in distance should be values close to each other, and a correlation value is set according to the closeness between the UEgrids.

For example, two-dimensional normal distribution centered on each UEgrid position is prepared, and the traffic at a certain position (UEgrid) is assumed to be the sum of all values of the two-dimensional normal distribution at that position.

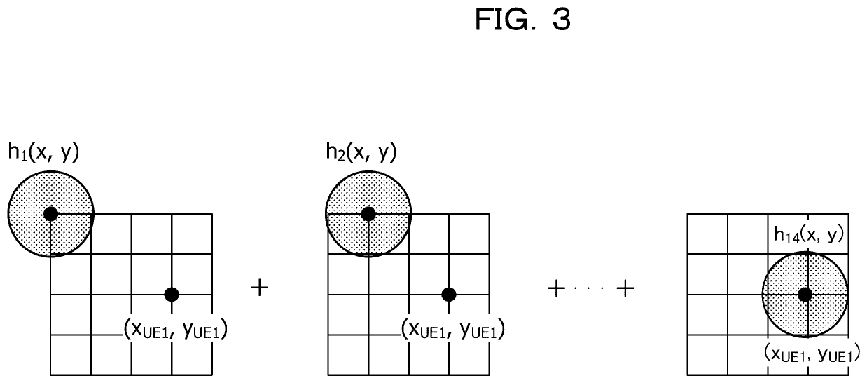

FIG. 3 is an explanatory diagram for explaining a relationship between elements. As illustrated in FIG. 3, it is assumed that traffic d₁ of the UEgrid₁ at a position (x_{UE1}, y_{UE1}) is the sum of two-dimensional normal distribution h₁, h₂, and so on centered on each position. A calculation formula for the traffic d₁ is as in the following formula (5).

$$\begin{matrix}[ Math . 5 ] & \\ {d}_{1} = {\sum }_{k = 1}^{m} {h}_{k} ( {x}_{UE 1} , {y}_{UE 1} ) & ( 5 )\end{matrix}$$

Here, m represents the number of UEgrids (number of positions). Furthermore, two-dimensional normal distribution hk is expressed by the following formula (6).

$$\begin{matrix}[ Math . 6 ] & \\ {h}_{k} ( z ) = \frac{1}{\sqrt{{( 2 π )}^{2} \vert Σ \vert}} exp ( - \frac{1}{2} {( z - {z}_{k} )}^{T} {Σ}^{- 1} ( z - {z}_{k} ) ) & ( 6 )\end{matrix}$$

Here, zₖ represents a vector (zₖ₁, zₖ₂) of positional coordinates of the UEgrid (k). Σ represents a variance-covariance matrix as in the following formula (7).

$$\begin{matrix}[ Math . 7 ] & \\ Σ = [ \begin{matrix}{σ}^{2} & 0 \\ 0 & {σ}^{2}\end{matrix} ] & ( 7 )\end{matrix}$$

As expressed in the formula (7), in the variance-covariance matrix, a diagonal term σ₂ indicates a distance between UEgrids or the like, and other elements are 0.

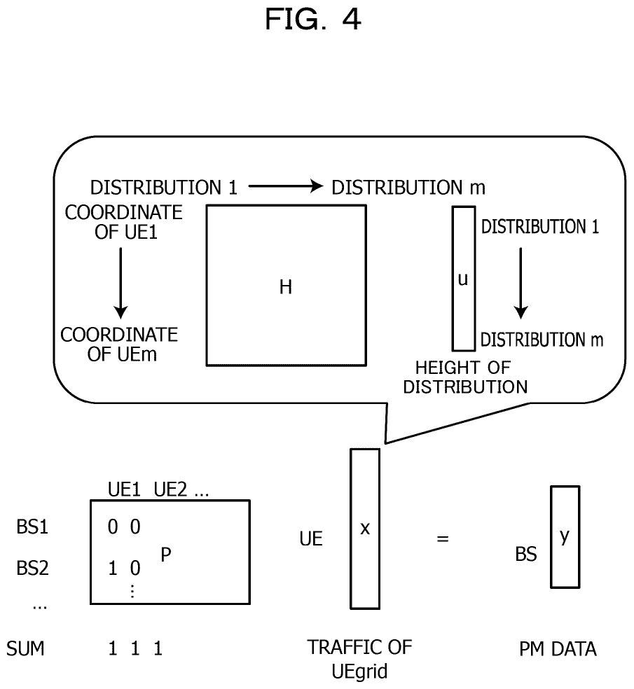

FIG. 4 is an explanatory diagram for explaining the outline of the traffic of the BS in consideration of the relationship between the elements. As illustrated in FIG. 4, the information processing apparatus according to the embodiment calculates the formulae (5) to (7) described above, and creates a matrix H in which values at individual UEgrid positions of the two-dimensional normal distribution centered on the individual UEgrid positions are stored. This matrix H is expressed by the following formula (8).

$$\begin{matrix}[ Math . 8 ] & \\ H = [ \begin{matrix}{h}_{1} ( {z}_{1} ) & … & {h}_{m} ( {z}_{1} ) \\ … & ⋱ & ⋮ \\ {h}_{1} ( {z}_{m} ) & … & {h}_{m} ( {z}_{m} )\end{matrix} ] & ( 8 )\end{matrix}$$

Next, the information processing apparatus according to the embodiment solves an optimization problem of the following formula (9) using a height of each normal distribution as a vector u and the PM data as a vector y. Note that the vector u corresponds to a vector [u₁, . . . uₘ]^{T} of a scaling factor of m pieces of normal distribution.

$$\begin{matrix}[ Math . 9 ] & \\ {arg min}_{u} {‖ PHu - y ‖}^{2} where u \geq 0 & ( 9 )\end{matrix}$$

Next, the information processing apparatus according to the embodiment obtains a vector x, which is the traffic of each UEgrid, as in the following formula (10).

$$\begin{matrix}[ Math . 10 ] & \\ x = Hu & ( 10 )\end{matrix}$$

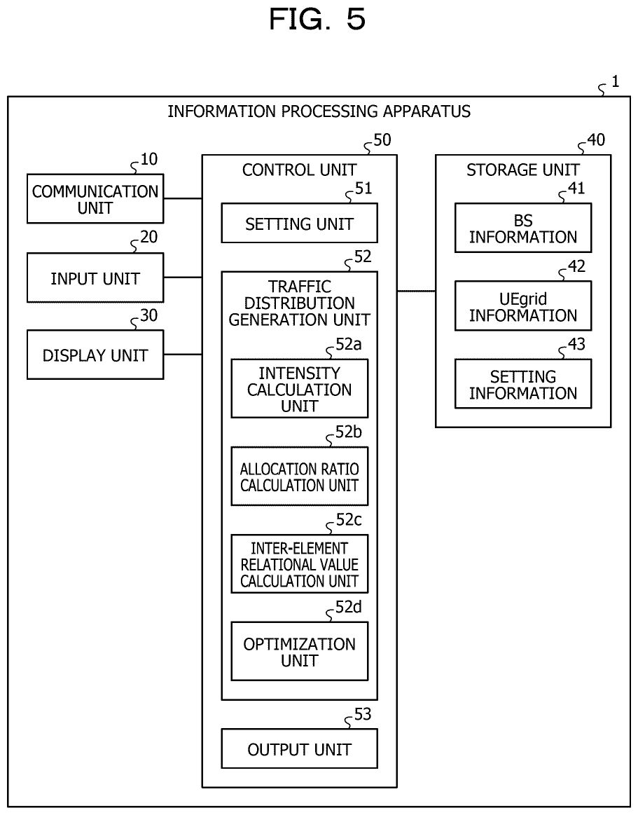

Next, details of the information processing apparatus according to the embodiment will be described. FIG. 5 is a block diagram illustrating an exemplary functional configuration of the information processing apparatus according to the embodiment.

As illustrated in FIG. 5, an information processing apparatus 1 includes a communication unit 10, an input unit 20, a display unit 30, a storage unit 40, and a control unit 50.

The communication unit 10 performs data communication with an external device and the like via a network. The input unit 20 receives an operation from a user. The display unit 30 displays a processing result of the control unit 50. For example, the display unit 30 displays traffic distribution generated by the control unit 50.

The storage unit 40 has BS information 41, UEgrid information 42, and setting information 43. For example, the storage unit 40 is implemented by a memory or the like.

The BS information 41 is information regarding each base station (BS). For example, the BS information 41 includes the transmission power, frequency, position, height, and traffic (PM data) of each BS.

The UEgrid information 42 is information regarding each UEgrid. For example, the UEgrid information 42 includes a position of each UEgrid. When there is an observation value of the traffic of the UEgrid at a specific time and position, the UEgrid information 42 also includes such information.

The setting information 43 is various setting values and the like to be used to obtain traffic distribution. For example, the setting information 43 includes a value related to a diagonal term (σ₂) of a variance-covariance matrix of normal distribution, and the like.

The control unit 50 includes a setting unit 51, a traffic distribution generation unit 52, and an output unit 53. For example, the control unit 50 is implemented by a processor.

The setting unit 51 is a processing unit that makes various settings related to the traffic distribution based on data input via the communication unit 10, the input unit 20, and the like. For example, the setting unit 51 receives an input from the user via the communication unit 10, the input unit 20, and the like, and sets positions of a plurality of grid points corresponding to the target area, positions of base stations, and the communication volume (PM data) of the base stations for each predetermined time. The setting unit 51 stores, in the storage unit 40, the set information as the BS information 41, the UEgrid information 42, and the setting information 43.

The traffic distribution generation unit 52 is a processing unit that estimates the communication volume of each UEgrid in a predetermined time based on the setting made by the setting unit 51. For example, the traffic distribution generation unit 52 includes an intensity calculation unit 52a, an allocation ratio calculation unit 52b, an inter-element relational value calculation unit 52c, and an optimization unit 52d.

The intensity calculation unit 52a is a processing unit that calculates intensity with combinations of all UEgrids and BSs based on the BS information 41 and the UEgrid information 42 read from the storage unit 40. For example, the traffic distribution generation unit 52 calculates the formula (1) described above, thereby calculating the intensity of each of the combinations of all UEgrids and BSs.

The allocation ratio calculation unit 52b is a processing unit that calculates an allocation ratio with respect to each BS for each UEgrid based on the intensity of each of the combinations of all UEgrids and BSs calculated by the intensity calculation unit 52a. For example, the allocation ratio calculation unit 52b calculates r_{i,k} as in the formula (3) described above, thereby obtaining the matrix P expressed in the formula (2).

The inter-element relational value calculation unit 52c is a processing unit that calculates a relation (correlation) value between elements of the vector x, which is the traffic of each UEgrid. For example, the inter-element relational value calculation unit 52c performs calculation as expressed in the formulae (5) to (8), thereby obtaining the matrix H related to the correlation (first correlation) of the communication volume based on the positions of the grid point and another grid point described above. Furthermore, the inter-element relational value calculation unit 52c obtains the correlation (second correlation) based on the time of the communication volume of the grid point (details will be described in the variation).

The optimization unit 52d is a processing unit that calculates (estimates) the traffic of each UEgrid, for example, the traffic distribution, by solving the optimization problem of the formula (9) described above based on the PM data (traffic for each BS) included in the BS information 41. For example, the optimization unit 52d solves the optimization problem of the formula (9) with the height of each normal distribution as the vector u and the PM data at a predetermined time as the vector y. Next, the optimization unit 52d obtains the vector x, which is the traffic of each UEgrid at the predetermined time, as in the formula (10).

The output unit 53 is a processing unit that outputs the traffic (traffic distribution) of each UEgrid generated (estimated) by the traffic distribution generation unit 52. For example, the output unit 53 displays and outputs the traffic distribution generated by the traffic distribution generation unit 52 on the display unit 30.

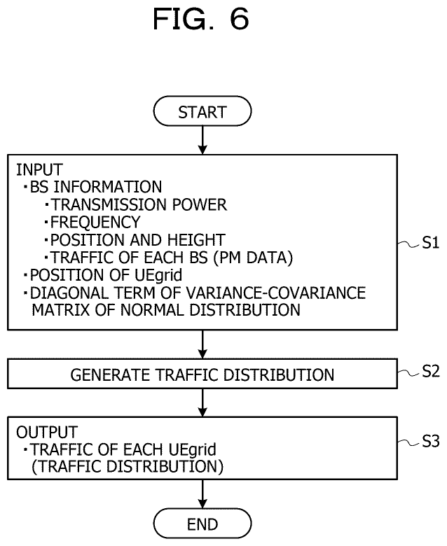

FIG. 6 is a flowchart illustrating exemplary operation of the information processing apparatus 1 according to the embodiment. As illustrated in FIG. 6, the setting unit 51 receives the BS information, such as the transmission power, frequency, position, and height of each BS, the traffic (PM data) of each BS, and the like, according to an input from the user or the like. Furthermore, the setting unit 51 receives information such as the position of the UEgrid, the diagonal term of the variance-covariance matrix of the normal distribution, and the like (S1). The setting unit 51 stores, in the storage unit 40, the received setting information as the BS information 41, the UEgrid information 42, and the setting information 43.

Next, the traffic distribution generation unit 52 performs a traffic distribution generation process for generating traffic (traffic distribution) for each UEgrid based on the BS information 41, the UEgrid information 42, and the setting information 43 stored in the storage unit 40 (S2). Next, the output unit 53 outputs the traffic distribution by, for example, displaying the traffic distribution generated by the traffic distribution generation unit 52 on the display unit 30 (S3).

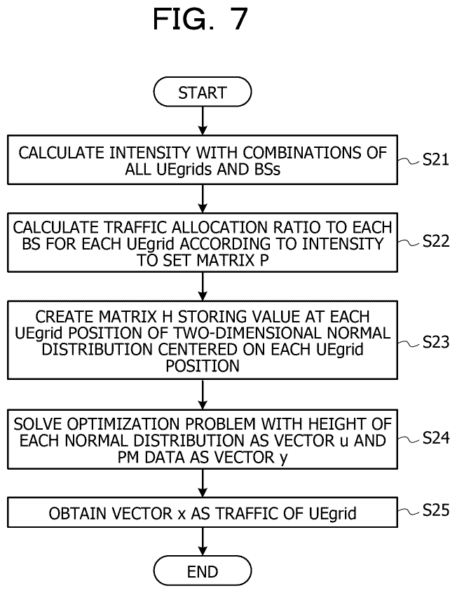

FIG. 7 is a flowchart illustrating an example of the traffic distribution generation process. As illustrated in FIG. 7, when the traffic distribution generation process starts, the intensity calculation unit 52a calculates the intensity with the combinations of all UEgrids and BSs (S21).

Next, the allocation ratio calculation unit 52b calculates the allocation ratio of the traffic with respect to each BS for each UEgrid according to the intensity calculated by the intensity calculation unit 52a, and sets it as the matrix P (S22).

Next, the inter-element relational value calculation unit 52c calculates the formulae (5) to (7) described above, and creates the matrix H in which values at individual UEgrid positions of the two-dimensional normal distribution centered on the individual UEgrid positions are stored (S23).

Next, the optimization unit 52d solves the optimization problem of the formula (9) with the height of each normal distribution as the vector u and the PM data in the predetermined time as the vector y (S24).

Next, the optimization unit 52d obtains the vector x, which is the traffic of each UEgrid at the predetermined time, as in the formula (10) (S25).

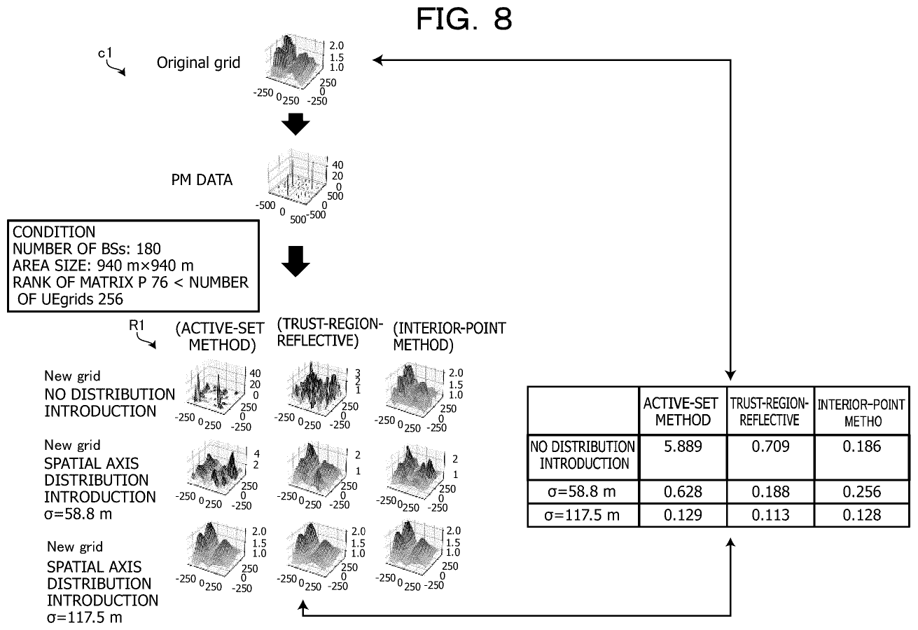

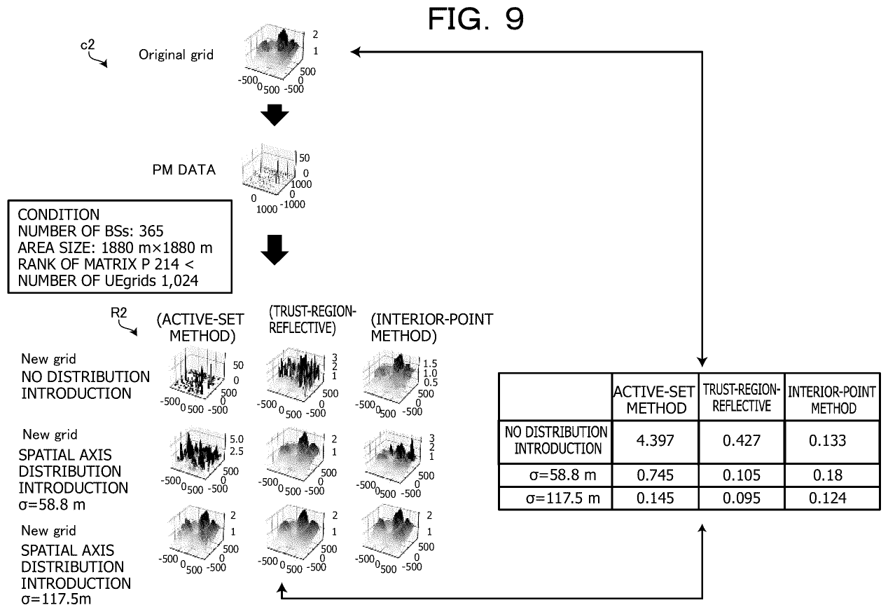

FIGS. 8 and 9 are explanatory diagrams for explaining exemplary calculation. As illustrated in FIGS. 8 and 9, in calculation examples c1 and c2, PM data is obtained from the original grid data based on actual traffic data.

The original grid data uses traffic data in Milan, which is data obtained from the Telecom Italia Big Data Challenge. In the original grid data, traffic is assigned to each area with one area=approximately 235 square meters.

The PM data is data created by simulation using the original grid data described above. In the simulation, connection between the UE and the BS is set such that the UE is coupled to the BS with the highest intensity.

Calculation results R1 and R2 are calculation results of the information processing apparatus 1 based on the PM data, for example, grid data (new grid) representing the traffic distribution. Here, in the calculation results R1 and R2, conditions such as the number of BSs, an area size, the number of ranks of the matrix P, and the like are changed.

Vertical columns in the calculation results R1 and R2 indicate that they are arithmetic results using the (active-set method), (trust-region-reflective), and (interior-point method). Horizontal columns in the calculation results R1 and R2 indicate the presence or absence of introduction of distribution of a spatial axis (two-dimensional normal distribution centered on each UEgrid position) corresponding to the correlation (first correlation) of the communication volume based on the positions of the grid point and another grid point. Note that, in the case of introducing the distribution of the spatial axis, values of σ are changed to 58.8 m and 117.5 m.

In the calculation examples c1 and c2, it is verified whether, based on the PM data, conversion into grid data (new grid) may be performed in a state where an error with respect to the original grid data is small. A table on the right represents a result of this verification, which indicates a root-mean-square error (RMSE) calculated between the original grid and the new grid.

As illustrated in the calculation examples c1 and c2, traffic distribution (new grid) close to the original grid is obtained based on the introduction of the distribution of the spatial axis having an appropriate σ.

Next, a variation of the information processing apparatus 1 according to the embodiment will be described. In this variation, the correlation (second correlation) based on the time of the communication volume of the grid point is added to the relational expression (Px=y) of the PM data of the BS together with the correlation (first correlation) of the communication volume based on the positions of the grid point and another grid point.

The correlation (second correlation) based on the time of the communication volume of the grid point reproduces the correlative relationship that the traffic at close times at individual grid points should be values close to each other, and a correlation value according to the closeness of time is set for the traffic of each UEgrid.

For example, in the case of adding the second correlation together with the first correlation, three-dimensional normal distribution centered on each UEgrid position and time is prepared. Then, it is assumed that the traffic at a certain position (UEgrid) at a certain time is the sum of the values of all the three-dimensional normal distributions at the position and at the time. For example, in the variation, the two-dimensional normal distribution in the case of adding the first correlation is extended to the three-dimensional normal distribution to which the time axis is added, and a calculation formula for the traffic d₁ in the variation is as in the following formula (11).

$$\begin{matrix}[ Math . 11 ] & \\ {d}_{1} = {{\sum }_{j = 1}}^{m \times l} {h}_{j} ( {x}_{1} , {y}_{1} , {t}_{1} ) & ( 11 )\end{matrix}$$

Note that, in a case of adding only the second correlation to the relational expression (Px=y) of the PM data of the BS, one-dimensional normal distribution centered on each time may be prepared for each UEgrid, and the sum of the values of all the one-dimensional normal distributions may be used.

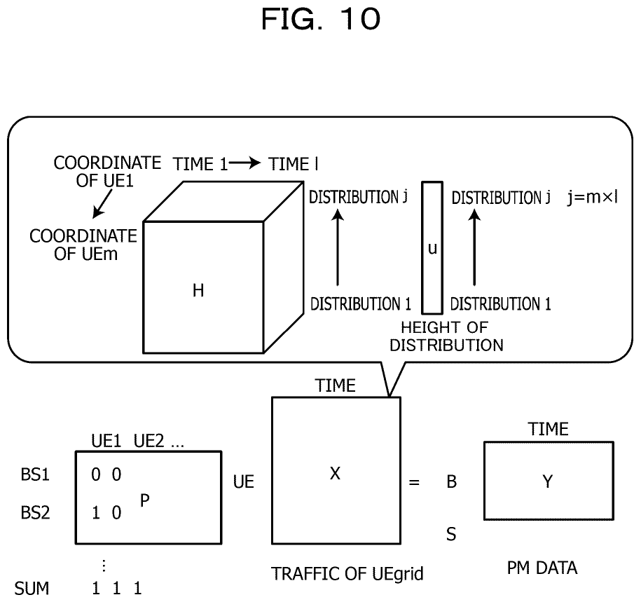

FIG. 10 is an explanatory diagram for explaining an outline of the traffic of the BS according to the variation. As illustrated in FIG. 10, in the variation, the information processing apparatus 1 creates a tensor H in which values at individual UEgrid positions and times of the three-dimensional normal distribution centered on the individual UEgrid positions and times are stored.

Next, in the variation, the information processing apparatus 1 solves an optimization problem of a formula (12) using the height of each normal distribution as the vector u and the PM data at all times as a matrix Y.

$$\begin{matrix}[ Math . 12 ] & \\ {arg min}_{u} {‖ PHu - Y ‖}^{2} where u \geq 0 & ( 12 )\end{matrix}$$

Next, in the variation, the information processing apparatus 1 obtains a matrix X, which is the traffic of the UEgrid at all times, as in a formula (13).

$$\begin{matrix}[ Math . 13 ] & \\ X = Hu & ( 13 )\end{matrix}$$

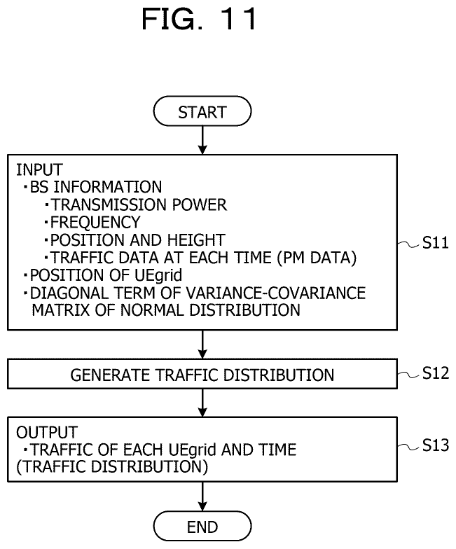

FIG. 11 is a flowchart illustrating exemplary operation of the information processing apparatus 1 according to the variation. As illustrated in FIG. 11, the setting unit 51 receives the BS information, such as the transmission power, frequency, position, and height of each BS, the traffic (PM data) at each time, and the like, according to an input from the user or the like. Furthermore, the setting unit 51 receives information such as the position of the UEgrid, the diagonal term of the variance-covariance matrix of the normal distribution, and the like (S11). The setting unit 51 stores, in the storage unit 40, the received setting information as the BS information 41, the UEgrid information 42, and the setting information 43.

Next, the traffic distribution generation unit 52 performs a traffic distribution generation process for generating traffic of each UEgrid at each time of all times (traffic distribution over all times) based on the BS information 41, the UEgrid information 42, and the setting information 43 stored in the storage unit 40 (S12).

Next, the output unit 53 outputs the traffic distribution by, for example, displaying the traffic distribution generated by the traffic distribution generation unit 52 for each UEgrid and time on the display unit 30 (S13).

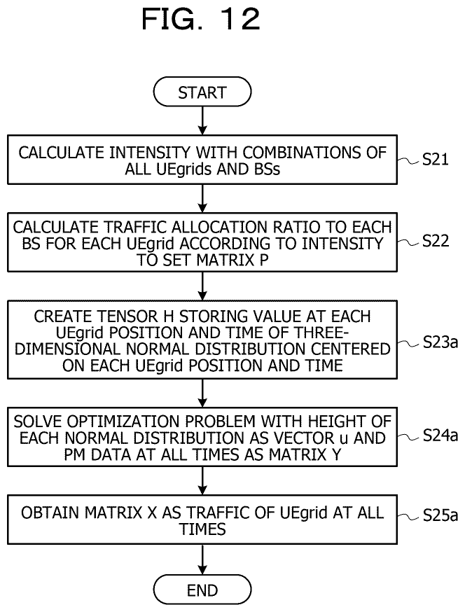

FIG. 12 is a flowchart illustrating an example of the traffic distribution generation process. As illustrated in FIG. 12, the traffic distribution generation process according to the variation performs processing related to S21 and S22 similar to that in FIG. 7.

Next, the inter-element relational value calculation unit 52c creates the tensor H in which the values at individual UEgrid positions and times of the three-dimensional normal distribution centered on the individual UEgrid positions and times are stored (S23a).

Next, the optimization unit 52d solves the optimization problem using the height of each normal distribution as the vector u and the PM data at all times as the matrix Y (S24a). Next, the optimization unit 52d obtains the matrix X, which is the traffic of the UEgrid at all times, as in the formula (13) (S25a).

As described above, the information processing apparatus 1 sets the positions of the plurality of grid points (UEgrids) corresponding to the target area, the positions of the base stations (BSs), and the communication volume of the base stations for each predetermined time. The information processing apparatus 1 estimates, based on the settings, the communication volume of each grid point at the predetermined time on the assumption of the terminal (UE) that communicates with the base station for each grid point. In this estimation, the information processing apparatus 1 estimates the communication volume of each grid point based on at least one of the first correlation of the communication volume based on the positions of the grid point and another grid point or the second correlation based on the time of the communication volume of the grid point.

As a result, the information processing apparatus 1 is enabled to more accurately estimate the communication volume of each grid point, for example, the traffic distribution in the target area, in consideration of at least one of the first correlation or the second correlation.

Furthermore, the information processing apparatus 1 estimates the communication volume of each grid point by solving the optimization problem for distributing the communication volume of the base station to each grid point, the optimization problem including at least one of the first correlation or the second correlation. As a result, at least one of the first correlation or the second correlation serves as a constraint in solving the optimization problem, whereby the information processing apparatus 1 may obtain a more appropriate optimal solution (communication volume of each grid point).

Furthermore, in the information processing apparatus 1, the first correlation is set to a correlation value according to the closeness in distance between the grid point and another grid point. As a result, the information processing apparatus 1 is enabled to estimate the communication volume of each grid point such that the communication volume correlates according to the closeness in distance between the grid point and another grid point.

Furthermore, in the information processing apparatus 1, the second correlation is set to a correlation value according to the closeness in time with respect to a predetermined time. As a result, the information processing apparatus 1 is enabled to estimate the communication volume of each grid point such that the communication volume correlates according to the closeness in time with respect to the predetermined time.

Furthermore, the information processing apparatus 1 further sets positions of a plurality of base stations and the communication volume of each base station for each predetermined time. The information processing apparatus 1 estimates the communication volume at each grid point with one or more base stations among the plurality of set base stations. As a result, the information processing apparatus 1 is enabled to estimate the traffic distribution in the case where the plurality of base stations exists in the target area.

Note that each component of each device illustrated in the drawings is not necessarily physically configured as illustrated in the drawings. For example, specific modes of distribution and integration of each device are not limited to those illustrated, and the whole or a part thereof may be configured by being functionally or physically distributed or integrated in any unit depending on various loads, use situations, and the like.

For example, constraints and conditions other than the first correlation and the second correlation described may be added to solve the optimization problem so that the solution may be further limited. As an example, a range may be set for the value of the traffic of the UEgrid. Furthermore, when an observation value of the traffic of the UEgrid at a specific time and position is included in the UEgrid information 42, the value may be applied to the optimization problem. Furthermore, the value of the traffic of the UEgrid in which the number of UEs is 0 may be set to 0.

Furthermore, since the traffic of the UEgrid is expressed by superposition of distribution functions (normal distribution), traffic at a position other than the defined UEgrid and at a time other than the time when the PM data is collected may also be calculated.

Furthermore, the normal distribution described above may be substituted with a radial basis function. Furthermore, the arrangement of the UEgrids may not be in a grid pattern, and predetermined positions (e.g., coarse and dense dots corresponding to population density, etc.) at which the traffic distribution may be obtained covering the entire target area may be used. Furthermore, the present embodiment is also applicable to a case where coverage of a macro BS and coverage of a small BS overlap as in a heterogeneous network.

Furthermore, all or any part of various processing functions of the setting unit 51, the traffic distribution generation unit 52, and the output unit 53 implemented by the control unit 50 of the information processing apparatus 1 may be executed on a central processing unit (CPU) (or microcomputer such as micro processing unit (MPU), micro controller unit (MCU), etc.). Furthermore, it is needless to say that all or any part of various processing functions may be executed on a program analyzed and executed by the CPU (or microcomputer such as MPU, MCU, etc.) or on hardware by wired logic. Furthermore, various processing functions implemented by the information processing apparatus 1 may be executed by a plurality of computers in cooperation through cloud computing.

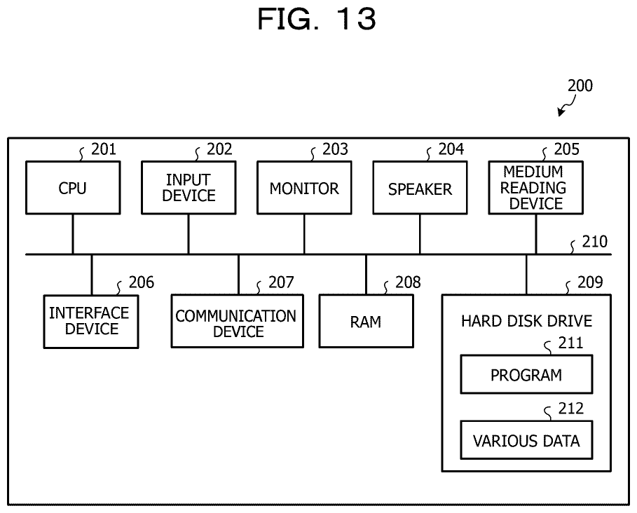

Meanwhile, the various types of processing described in the embodiment above may be implemented by a computer executing a program prepared in advance. Thus, hereinafter, an exemplary computer configuration (hardware) for executing a program having functions similar to those in the embodiment described above will be described. FIG. 13 is an explanatory diagram for explaining an exemplary computer configuration.

As illustrated in FIG. 13, a computer 200 includes a CPU 201 that executes various kinds of arithmetic processing, an input device 202 that receives data input, a monitor 203, and a speaker 204. Furthermore, the computer 200 includes a medium reading device 205 that reads a program or the like from a storage medium, an interface device 206 to be coupled to various devices, and a communication device 207 to be coupled to and communicate with an external device in a wired or wireless manner. Furthermore, the computer 200 includes a random access memory (RAM) 208 that temporarily stores various types of information, and a hard disk drive 209. Furthermore, each of the units (201 to 209) in the computer 200 is coupled to a bus 210.

The hard disk drive 209 stores a program 211 for executing various types of processing in the functional configurations (e.g., setting unit 51, traffic distribution generation unit 52, and output unit 53) described in the embodiment above. Furthermore, the hard disk drive 209 stores various types of data 212 to be referred to by the program 211. The input device 202 receives, for example, an input of operation information from an operator. The monitor 203 displays, for example, various screens to be operated by the operator. The interface device 206 is coupled to, for example, a printing device or the like. The communication device 207 is coupled to a communication network such as a local area network (LAN), and exchanges various types of information with an external device via the communication network.

The CPU 201 reads the program 211 stored in the hard disk drive 209, and loads it in the RAM 208 for execution, thereby performing various types of processing related to the functional configurations described above (e.g., setting unit 51, traffic distribution generation unit 52, and output unit 53). Note that the program 211 is not necessarily stored in the hard disk drive 209. For example, the program 211 stored in a storage medium readable by the computer 200 may be read and executed. The storage medium readable by the computer 200 corresponds to, for example, a portable recording medium such as a compact disc read-only memory (CD-ROM), a digital versatile disc (DVD), or a universal serial bus (USB) memory, a semiconductor memory such as a flash memory, a hard disk drive, or the like. Furthermore, the program 211 may be prestored in a device coupled to a public line, the Internet, the LAN, or the like, and the computer 200 may read the program 211 from such a device to execute it.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute an estimation process comprising:
setting a plurality of predetermined positions, a position of a base station, and communication volume of the base station for each predetermined time in a target area; and
estimating the communication volume of each of the predetermined positions based on at least one of a first correlation of the communication volume based on the predetermined positions and another predetermined position or a second correlation based on a time of the communication volume of the predetermined positions at a time of estimating the communication volume of each of the predetermined positions in the predetermined time on an assumption of a terminal that communicates with the base station for each of the predetermined positions based on the setting.

2. The non-transitory computer-readable recording medium according to claim 1, wherein
the predetermined positions include positions that correspond to grid points when the target area is divided in a grid pattern.

3. The non-transitory computer-readable recording medium according to claim 1, wherein
the estimating estimates the communication volume of each of the predetermined positions by solving an optimization problem that distributes the communication volume of the base station to each of the predetermined positions and includes at least one of the first correlation or the second correlation.

4. The non-transitory computer-readable recording medium according to claim 1, wherein
the first correlation includes a correlation value according to closeness in distance between the predetermined positions and the another predetermined position.

5. The non-transitory computer-readable recording medium according to claim 1, wherein
the second correlation includes a correlation value according to closeness in time with respect to the predetermined time.

6. The non-transitory computer-readable recording medium according to claim 1, wherein
the setting further sets positions of a plurality of the base stations and the communication volume of each of the base stations for each of the predetermined time, and
the estimating estimates the communication volume with one or the plurality of base stations at each of the predetermined positions.

7. An estimation method comprising:
setting a plurality of predetermined positions, a position of a base station, and communication volume of the base station for each predetermined time in a target area; and
estimating the communication volume of each of the predetermined positions based on at least one of a first correlation of the communication volume based on the predetermined positions and another predetermined position or a second correlation based on a time of the communication volume of the predetermined positions at a time of estimating the communication volume of each of the predetermined positions in the predetermined time on an assumption of a terminal that communicates with the base station for each of the predetermined positions based on the setting.

8. The estimation method according to claim 7, wherein
the predetermined positions include positions that correspond to grid points when the target area is divided in a grid pattern.

9. The estimation method according to claim 7, wherein
the estimating estimates the communication volume of each of the predetermined positions by solving an optimization problem that distributes the communication volume of the base station to each of the predetermined positions and includes at least one of the first correlation or the second correlation.

10. The estimation method according to claim 7, wherein
the first correlation includes a correlation value according to closeness in distance between the predetermined positions and the another predetermined position.

11. The estimation method according to claim 7, wherein
the second correlation includes a correlation value according to closeness in time with respect to the predetermined time.

12. The estimation method according to claim 7, wherein
the setting further sets positions of a plurality of the base stations and the communication volume of each of the base stations for each of the predetermined time, and
the estimating estimates the communication volume with one or the plurality of base stations at each of the predetermined positions.

13. An information processing apparatus comprising:
a memory; and
a processor coupled to the memory and configured to:
set a plurality of predetermined positions, a position of a base station, and communication volume of the base station for each predetermined time in a target area; and
estimate the communication volume of each of the predetermined positions based on at least one of a first correlation of the communication volume based on the predetermined positions and another predetermined position or a second correlation based on a time of the communication volume of the predetermined positions at a time of estimating the communication volume of each of the predetermined positions in the predetermined time on an assumption of a terminal that communicates with the base station for each of the predetermined positions based on the setting.

14. The information processing apparatus according to claim 13, wherein
the predetermined positions include positions that correspond to grid points when the target area is divided in a grid pattern.

15. The information processing apparatus according to claim 13, wherein
the processor estimates the communication volume of each of the predetermined positions by solving an optimization problem that distributes the communication volume of the base station to each of the predetermined positions and includes at least one of the first correlation or the second correlation.

16. The information processing apparatus according to claim 13, wherein
the first correlation includes a correlation value according to closeness in distance between the predetermined positions and the another predetermined position.

17. The information processing apparatus according to claim 13, wherein
the second correlation includes a correlation value according to closeness in time with respect to the predetermined time.

18. The information processing apparatus according to claim 13, wherein
the processor further sets positions of a plurality of the base stations and the communication volume of each of the base stations for each of the predetermined time, and estimates the communication volume with one or the plurality of base stations at each of the predetermined positions.
